(19) United States
(12) Patent Application Publication
(10) Pub. No.: US 2007/0166064 A1
(43) Pub. Date: Jul. 19, 2007

(54) IMAGE OUTPUT APPARATUS, OUTPUT IMAGE CONTROL METHOD AND OUTPUT IMAGE CONTROL PROGRAM

(75) Inventors: Naoki TAKAHASHI, Kyoto (JP); Kazumasa HAYASHI, Hyogo (JP); Akinori TOYODA, Osaka (JP); Masao OOTSUKA, Osaka (JP); Hideki YASUDA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/616,974

(22) Filed: Dec. 28, 2006

(30) Foreign Application Priority Data
Jan. 16, 2006 (JP) 2006/007089

(51) Int. Cl. G03G 15/00

(52) U.S. Cl. 399/49

(57) ABSTRACT

An image output apparatus capable of controlling the image density for a specific level in a short time and with accuracy and no control failure. When the values of manipulated variables that are control parameters of the output image quality or a controlled variable are calculated and the parameter values become out of the practically settable range in the course of obtaining new manipulated variables adjusted for controlling the output image quality for a specific level, the image density control unit of the image output apparatus corrects the data in the image density database that are used for comparison in obtaining the parameter values according to the current environmental state and repeats the calculation, whereby no control failure occurs and optimum parameter values are obtained; consequently, the output image quality can be controlled for a target level in a stable manner.

### FIELD OF THE INVENTION

The present invention relates to a technique for controlling the quality of output images for a target level in image forming apparatuses such as copy, facsimile, printer, and multifunction peripherals and other image output apparatuses.

### BACKGROUND OF THE INVENTION

In electrophotographic image forming apparatuses, the image density is generally controlled using a density patch (also simply termed a patch). The patch is an image used as a reference for measuring the optical density (also simply termed the density) of output images (an image used as a reference for obtaining an index and constituted by a pattern and, therefore, also termed a reference pattern). The output image includes a printed image on printing paper (also simply termed paper) and a formed image that is a toner image formed on a photo conductor (an image formed by toner). The density of the patch image (the density of the patch image is also simply termed “the patch density”) is used as an index of the output image density level (“the image density” is used to indicate not only the output image density but also the level thereof in this specification). The image forming apparatus controls the image density as one of the qualities of the output images for a specific level. This is because the reproducibility of printed images is impaired as a result of the environment in which the apparatus is placed and changes over time in performance characteristics of the apparatus (the states after the apparatus is subject to such changes are termed the environmental states) unless the image density is controlled. For controlling the image density, the image forming apparatus detects the density of the density patch and gives feedback of the detected value (termed the detected density) for adjustment for controlling the image density for a target level, whereby image forming characteristics (also termed image density characteristics as to the image density) are manipulated according to the environmental states at the time.

For example, in an image forming apparatus using laser beams, the voltage applied to the grid electrode of a scorotron electrifier having a grid electrode (this voltage is termed the grid voltage) or the irradiation rate of a laser beam (termed the laser power) is adjusted according to the detected density of the density patch so as to manipulate image forming characteristics. Highly accurate adjustment is required for highly accurate manipulation. Conventional techniques require a large volume of information (data) regarding relationships between the image densities and their detected values in various environmental states for such adjustment. It is difficult to reduce the number of density patches that have to be formed before the image density falls within a specific target range.

The Japanese Laid-Open Patent Application Publication No. H10-63048 discloses an image forming apparatus in which the image density is controlled using prior control case (also simply termed “case”) data. Here, the control case data consist of the values of state quantities associated with the values of manipulated variables and the detected values of density patches. The state quantities are indices of the environmental states such as temperature and humidity. The state quantities are considered to be substituted by the times incidents occur. The manipulated variables are, for example, the grid voltage of the electrifier and the laser power or their combination (termed “a set of manipulated variables”) (“the manipulated variables” in this specification primarily means “a set of manipulated variables”). The density patch includes a solid density patch that is a high image density (the coverage in a reference pattern is, for example, 100%) and a highlight density patch that is a low image density (the coverage is, for example, 20%). For controlling the image density for a specific level, the image forming apparatus detects the state quantities, extracts the control case data according to the detected value (having similar state quantities), and adjusts the manipulated variables using the extracted control case data so as to control the densities of both patches for specific target values.

In this image forming apparatus, the cases are presented by dots in a control case space as shown in FIG. 4 of the above mentioned publication (a space having coordinate axes for the components of control cases). Multiple cases are assumed to form a plane in the control case space when their state quantities are not substantially changed. In this image forming apparatus, the image density is controlled for a specific level as follows.

At least three sets of manipulated variables (P1 through P3) having substantially constant state quantities are used to define a plane. Each case includes detected densities (B1 through B3) and (H1 through H3) for two different patches. FIG. 4 of the above mentioned publication presents two case planes BP and HP for the two different corresponding patches.

Furthermore, as shown in FIG. 5 of the above mentioned publication, target densities (the values of target “patch densities”) for the two different patches are given by the planes BTP and HTP, respectively. The line of intersection BTL between the solid density case plane BP and the solid density target density plane BTP presents a set of manipulated variables realizing the target density of the solid density. Then, the line of intersection HTL between the highlight density case plane HP and the highlight density target density plane HTP presents a set of manipulated variables realizing the target density of the highlight density. The intersection point TP between the lines of intersection BLT and HTL projected on the plane formed by the grid voltage and laser power presents the values of the manipulated variable realizing the target densities of both the solid density and the highlight density.

The image forming apparatus disclosed in the Japanese Laid-Open Patent Application Publication No. H10-63048 controls the image density for a specific level by operating the electrifier and the laser beam using the values of the manipulated variables obtained as described above. In the above described publication, at least three sets of control cases corresponding to the state quantities at the time are prepared to control the image density. Therefore, the number of the density patches formed is reduced compared to conventional techniques.

### SUMMARY OF THE INVENTION

However, because the environmental state varies on each occasion, the prior art image forming apparatus described above should accumulate control cases for a number of state quantities sampled in various environmental states and carefully sampled over their possible ranges by that occasion in order to prepare appropriate control cases corresponding to the state quantities at the time.

In other words, control case data for the changed environmental states are necessary for the adjustment to control the image density. On the other hand, the state quantities change in various manners throughout the period of service and during the operation as a result of changes in environmental factors in which the apparatus is placed such as temperature and humidity and in changes over time in performance characteristics. Therefore, the image forming apparatus accumulates control case data on each occasion throughout the period of service on a timely basis, whereby adjustment for subsequent control of the image density is available using the accumulated control case data. In order to improve the accuracy of adjustment, the control case data of which the environmental state is the same as or similar to that at the time of adjustment are necessary. To this end, a large volume of various control case data should be collected in practice.

The plane defined by three sets of cases may not present the actual characteristics of the apparatus in some cases. For example, the image density does not always linearly change in relation to the manipulated variables. Furthermore, in a complex system such as the electrophotographic process, the image density changes non-linearly in relation to the state quantities.

Therefore, if three sets of cases are inappropriate, the dissociation between the plane defined based on the cases and inherent non-linear characteristics is increased. As the dissociation is increased, the control case plane and target density plane do not intersect within a range available for the actual manipulated variables, whereby the image density cannot be controlled.

Such problems occur when the output image quality is controlled for a specific target level using physical quantities other than the image density, such as brightness, hue, and gloss, in a similar manner.

As described above, the prior art image forming apparatus needs to collect a large volume of various control case data for adjustment to control the image density in practice. Furthermore, the prior art control method has a problem that the calculated values of manipulated variables may be out of the actual settable range and lead to control failure in some cases.

The present invention dissolves the problems in the prior art and provides an image output apparatus, an output image control method, and an output image control program, with which when once calculated values of manipulated variables are out of the settable range, they are recalculated according to the current operation state of the apparatus to yield values of the manipulated variables within the settable range, whereby the output image quality is controlled for a specific target level in a stable manner.

In order to achieve the above purpose, the present invention provides an image output apparatus for outputting an image, the apparatus having a function to manipulate characteristics regarding qualities including an optical density of the image outputted by the apparatus through adjustment for controlling the qualities for a specific level in relation to environmental states including an environment in which the apparatus is placed and changes over time in performance characteristics, the apparatus comprising: a data storage unit configured to store representative data indicating a relationship between manipulated variables and controlled variables for predetermined representative manipulated variables in a specific environmental state, said manipulated variables being variables used for manipulating characteristics regarding said qualities, said controlled variables being indices of said qualities in a reference pattern that is an image used as a reference for obtaining the indices; and a manipulated variables adjustment unit configured to obtain new manipulated variables adjusted for controlling said qualities for a specific level by comparing the data indicating the relationship between said variables for the manipulated variables determined or calculated at the time in said environmental state at the time with representative data stored in said data storage unit in the course of controlling said variables for a specific level, and wherein said manipulated variables adjustment unit corrects the data in said data storage unit based on the data indicating the relationship between said variables in said environmental state at the time when necessary in the course of controlling said qualities for a specific level to obtain said new manipulated variables.

The present invention also provides an image forming apparatus for forming a toner image according to an image signal, the apparatus having a function to manipulate characteristics regarding qualities including an optical density of the toner image formed by said apparatus through adjustment for controlling said qualities for a specific level in relation to environmental states including an environment in which the apparatus is placed and changes over time in performance characteristics, the apparatus comprising: an electrifier configured to uniformly charge the surface of a photo conductor on which an electrostatic latent image that is an electrostatic image is formed, to a bias voltage of an arbitrary level within a specific range; a laser output unit configured to form said electrostatic latent image according to the image signal on said photo conductor surface by exposing said uniformly charged photo conductor surface with an arbitrary exposure rate within a specific range; a developing unit configured to develop said electrostatic latent image on the photo conductor surface using toner at a second bias voltage within a specific range according to said bias voltage of an arbitrary level so as to form said toner image on said photo conductor surface; a sensor configured to detect the optical density of said toner image formed on said photo conductor surface in a reference pattern, said reference pattern being an image used as a reference for obtaining indices; a database configured to store representative data indicating a relationship between the values of said bias voltage and exposure rate that are the manipulated variables with said electrifier and laser output unit and the detected density that is a detected value of the optical density of the toner image in said reference pattern used as an index of said qualities for predetermined representative manipulated variables in a specific environmental state; and a manipulated variables adjustment configured to obtain said manipulated variables adjusted for controlling said qualities for a specific level by comparing the data indicating the relationship between said values for the manipulated variables determined or calculated at the time in said environmental state at the time with representative data stored in said database in the course of controlling said qualities for a specific level, and wherein said manipulated variables adjustment unit corrects the data in said database based on the data indicating the relationship between said values in said environmental state at the time when necessary in the course of controlling said qualities for a specific level to obtains said new manipulated variables.

The present invention further provides an output image control method for controlling, with an image output apparatus being capable of image output and having a function to manipulate characteristics regarding qualities including an optical density of an image outputted by the apparatus, the qualities for a specific value in relation to environmental states including an environment in which said apparatus is placed and changes over time in performance characteristics, the method comprising the steps of: storing representative data indicating a relationship between manipulated variables and controlled variables for predetermined representative manipulated variables in a specific environmental state, said manipulated variables being variables used for manipulating characteristics regarding said qualities, said controlled variables being indices of said qualities in a reference pattern that is an image used as a reference for obtaining the indices; and obtaining new manipulated variables adjusted for controlling said qualities for a specific level by comparing the data indicating the relationship between said variables for said manipulated variables determined or calculated at the time in said environmental state at the time with representative data stored in said database in the course of controlling said qualities for a specific level, and wherein the step of obtaining said new manipulated variables is a step of obtaining said new manipulated variables after the data in said database is corrected based on the data indicating the relationship between said variables in said environmental state at the time when necessary.

Using the construction described above, when the values of manipulated variables that are control parameters of the output image quality or a controlled variable are calculated and the parameter values become out of the practically settable range in the course of obtaining new manipulated variables adjusted for controlling the output image quality for a specific level, the present invention corrects the data in the data storage unit or in the database that are used for comparison in obtaining the parameter values according to the current environmental state and repeats the calculation, whereby no control failure occurs and optimum parameter values are obtained; consequently, the output image quality can be controlled for a target level in a stable manner.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic illustration showing the structure of an image forming apparatus according to an embodiment of the present invention.

FIG. 2 is a block diagram showing functions regarding the image density control of the image forming apparatus.

FIG. 3 is an illustration showing an exemplary reference pattern (density patches).

FIG. 4 is an illustration for explaining an exemplary structure of the image density database.

FIG. 5 is an illustration showing exemplary image densities of the solid density patch stored in the image density database.

FIG. 6 is a flowchart for explaining the steps of the output image control method according to an embodiment of the present invention.

FIG. 7 is an illustration showing an image density space for explaining the correction step of the image density database.

FIG. 8 is another illustration showing an image density space for explaining the correction step of the image density database.

FIG. 9 is further another illustration showing an image density space for explaining the correction step of the image density database.

### DETAILED DESCRIPTION OF THE INVENTION

In an aspect of the present invention provided is an image output apparatus for outputting an image, the apparatus having a function to manipulate characteristics regarding qualities including an optical density of the image outputted by the apparatus through adjustment for controlling the qualities for a specific level in relation to environmental states including an environment in which the apparatus is placed and changes over time in performance characteristics, the apparatus comprising: a data storage unit configured to store representative data indicating a relationship between manipulated variables and controlled variables for predetermined representative manipulated variables in a specific environmental state, said manipulated variables being variables used for manipulating characteristics regarding said qualities, said controlled variables being indices of said qualities in a reference pattern that is an image used as a reference for obtaining the indices; and a manipulated variables adjustment unit configured to obtain new manipulated variables adjusted for controlling said qualities for a specific level by comparing the data indicating the relationship between said variables for the manipulated variables determined or calculated at the time in said environmental state at the time with representative data stored in said data storage unit in the course of controlling said variables for a specific level, and wherein said manipulated variables adjustment unit corrects the data in said data storage unit based on the data indicating the relationship between said variables in said environmental state at the time when necessary in the course of controlling said qualities for a specific level to obtain said new manipulated variables.

Using the structure described above, for example, with regard to the image density, which is one of the qualities, for controlling the image density for a specific target level by obtaining a control rule as a reference near the target density in the current environmental state and adjusting the manipulated variables for optimum in the current environmental state according to the obtained control rule, the control rule is obtained by defining a control rule plane (image density plane) presenting the control rule. In such a case, when the values of the manipulated variables that are control parameters of the image density or a controlled variable are calculated and the calculated values of the manipulated variables are out of the manipulation available range in the course of obtaining new manipulated variables adjusted for controlling the image density quality for a specific level, the data in the data storage unit that are used for comparison to obtain the new values of the manipulated variables are corrected using the detected densities of the formed density patches and then the image output apparatus repeats the calculation, whereby the image density level can be controlled using optimized parameters without control failure.

The control rule obtained using the patches formed as described above predicts points on the line of intersection between the control rule plane and the target density plane that is a set of points for realizing the target density. Therefore, with the control rule plane being defined using the patches, the dissociation between the control rule plane and the actual apparatus characteristics is prevented. Consequently, the image density can be controlled in a more stable manner. Furthermore, fluctuations in state quantities are less influential. Therefore, it is unnecessary to collect a number of control cases while the apparatus is in operation.

As described above, the image output apparatus can control the output image quality for a target level in a stable manner.

In this image output apparatus, the manipulated variables adjustment unit can temporarily correct and use the data in the data storage to obtain new manipulated variables once again when the new manipulated variables are out of the manipulation available range of the apparatus.

With the manipulated variables adjustment unit temporarily correcting and using the data in the data storage to obtain new manipulated variables once again when the new manipulated variables are out of the manipulation available range of the apparatus, the image output apparatus repeats the calculation without updating the data in the data storage and undergoes no control failure. Furthermore, it does not update the data in the data storage in an unusual environmental state that is far different from the normal state, therefore assuring consistent control.

The manipulated variables adjustment unit can correct and update the data in the data storage to obtain new manipulated variables once again when the new manipulated variables are out of the manipulation available range of the apparatus.

With the manipulated variables adjustment unit correcting and updating the data in the data storage to obtain new manipulated variables once again when the new manipulated variables are out of the manipulation available range of the apparatus, the image output apparatus repeats the calculation with the data in the data storage being updated and undergoes no control failure. Furthermore, it updates the data in the data storage, for example, in association with slow changes over time of the apparatus; consequently the control is suitable for the current environmental state, therefore improving the accuracy.

The manipulated variables adjustment unit can determine whether to temporarily correct and use the data in the data storage unit or to correct and update the data in the data storage unit to obtain new manipulated variables once again when the new manipulated variables are out of the manipulation available range of the apparatus.

With this structure, the data in the data storage is not updated, for example, in an unusual environmental state that is far different from the normal state, therefore assuring consistent control. Furthermore, the data are updated, for example, in association with slow changes over time of the apparatus; consequently, the control is suitable for the current environmental state, therefore improving the accuracy.

The image output apparatus can determine whether the data in the data storage is temporarily corrected and used or updated based on the environmental state.

Determining whether the data in the data storage is temporarily corrected and used or updated based on the environmental state, the apparatus undergoes no control failure and does not update the data in the data storage, for example, in an unusual environmental state that is far different from the normal state, therefore assuring consistent control. Furthermore, it updates the data, for example, in association with slow changes over time of the apparatus; consequently, the control is suitable for the current environmental state, therefore increasing the accuracy.

The manipulated variables adjustment unit can correct the data in the data storage unit by linearly transforming the data in the data storage unit based on the relationship between the variables in the environmental state at the time.

With this structure, the data can be corrected in an accurate and simple manner with intended effects. In addition, less processing time is required.

In another aspect of the present invention, provided is An image forming apparatus for forming a toner image according to an image signal, the apparatus having a function to manipulate characteristics regarding qualities including an optical density of the toner image formed by said apparatus through adjustment for controlling said qualities for a specific level in relation to environmental states including an environment in which the apparatus is placed and changes over time in performance characteristics, the apparatus comprising: an electrifier configured to uniformly charge the surface of a photo conductor on which an electrostatic latent image that is an electrostatic image is formed, to a bias voltage of an arbitrary level within a specific range; a laser output unit configured to form said electrostatic latent image according to the image signal on said photo conductor surface by exposing said uniformly charged photo conductor surface with an arbitrary exposure rate within a specific range; a developing unit configured to develop said electrostatic latent image on the photo conductor surface using toner at a second bias voltage within a specific range according to said bias voltage of an arbitrary level so as to form said toner image on said photo conductor surface; a sensor configured to detect the optical density of said toner image formed on said photo conductor surface in a reference pattern, said reference pattern being an image used as a reference for obtaining indices; a database configured to store representative data indicating a relationship between the values of said bias voltage and exposure rate that are the manipulated variables with said electrifier and laser output unit and the detected density that is a detected value of the optical density of the toner image in said reference pattern used as an index of said qualities for predetermined representative manipulated variables in a specific environmental state; and a manipulated variables adjustment configured to obtain said manipulated variables adjusted for controlling said qualities for a specific level by comparing the data indicating the relationship between said values for the manipulated variables determined or calculated at the time in said environmental state at the time with representative data stored in said database in the course of controlling said qualities for a specific level, and wherein said manipulated variables adjustment unit corrects the data in said database based on the data indicating the relationship between said values in said environmental state at the time when necessary in the course of controlling said qualities for a specific level to obtains said new manipulated variables.

Using this structure, for example, with regard to the image density, which is one of the qualities, for controlling the image density for a specific target level by obtaining a control rule as a reference near the target density in the current environmental state and adjusting the manipulated variables for optimum in the current environmental state according to the obtained control rule, the control rule is obtained by defining a control rule plane (image density plane) presenting the control rule. In such a case, when the values of the manipulated variables that are control parameters of the image density or a controlled variable are calculated and the calculated values of the manipulated variables are out of the manipulation available range in the course of obtaining new manipulated variables adjusted for controlling the image density quality for a specific level, the data in the data storage unit that are used for comparison to obtain the new values of the manipulated variables are corrected using the detected densities of the formed density patches and then the image forming apparatus repeats the calculation, whereby the image density level can be controlled using optimized parameters without control failure.

The control rule obtained using the patches formed as described above predicts points on the line of intersection between the control rule plane and the target density plane that is a set of points for realizing the target density. Therefore, with the control rule plane being defined using the patches, the dissociation between the control rule plane and the actual apparatus characteristics is prevented. Consequently, the image density can be controlled in a more stable manner. Furthermore, fluctuations in state quantities are less influential. Therefore, it is unnecessary to collect a number of control cases while the apparatus is in operation.

As described above, the image forming apparatus can control the toner image quality for a target level in a stable manner.

Also in this image forming apparatus, the manipulated variables adjustment unit can temporarily correct and use the data in the database to obtain new manipulated variables once again when the new manipulated variables are out of the manipulation available range of the apparatus.

With the manipulated variables adjustment unit temporarily correcting and using the data in the data storage to obtain new manipulated variables once again when the new manipulated variables are out of the manipulation available range of the apparatus, the image forming apparatus repeats the calculation without updating the data in the database and undergoes no control failure. Furthermore, it does not update the data in the database, for example, in an unusual environmental state that is far different from the normal state, therefore assuring consistent control.

The manipulated variables adjustment unit can correct and update the data in the database to obtain new manipulated variables once again when the new manipulated variables are out of the manipulation available range of the apparatus.

With the manipulated variables adjustment unit correcting and updating the data in the database to obtain new manipulated variables once again when the new manipulated variables are out of the manipulation available range of the apparatus, the image forming apparatus repeats the calculation with the data in the database being updated and undergoes no control failure. Furthermore, it updates the data in the database, for example, in association with slow changes over time of the apparatus; consequently, the control is suitable for the current environmental state, therefore increasing the accuracy.

The manipulated variables adjustment unit can determine whether to temporarily correct and use the data in the database or to correct and update the data in the database to obtain new manipulated variables once again when the new manipulated variables are out of the manipulation available range of the apparatus.

With this structure, the data in the database are not updated, for example, in an unusual environmental state that is far different from the normal state, assuring consistent control. Furthermore, the data are updated, for example, in association with slow changes over time of the apparatus; consequently, the control is suitable for the current environmental state, therefore increasing the accuracy.

The image forming apparatus can determine whether the data in the database is temporarily corrected and used or updated based on the environmental state.

The apparatus determines whether the data in the database is temporarily corrected and used or updated based on the environmental state, thereby undergoing no control failure. On that basis, the data in the database is not updated, for example, in an unusual environmental state that is far different from the normal state, therefore assuring consistent control. In addition, the data are updated, for example, in association with slow changes over time of the apparatus; consequently, the control is suitable for the current environmental state, therefore increasing the accuracy.

The manipulated variables adjustment unit can correct the data in the database by linearly transforming the data in the database based on the relationship between the values in the environmental state at the time.

With this structure, the data in the database are corrected by the manipulated variables adjustment unit by linearly transforming the data in the database based on the data presenting the relationship between the variables in the environmental state at the time, whereby the data can be corrected in an accurate and simple manner with intended effects. In addition, less processing time is required.

In another aspect of the present invention provided is an output image control method for controlling, with an image output apparatus being capable of image output and having a function to manipulate characteristics regarding qualities including an optical density of an image outputted by the apparatus, the qualities for a specific value in relation to environmental state including an environment in which said apparatus is placed and changes over time in performance characteristics, the method comprising the steps of: storing representative data indicating a relationship between manipulated variables and controlled variables for predetermined representative manipulated variables in a specific environmental state, said manipulated variables being variables used for manipulating characteristics regarding said qualities, said controlled variables being indices of said qualities in a reference pattern that is an image used as a reference for obtaining the indices; and obtaining new manipulated variables adjusted for controlling said qualities for a specific level by comparing the data indicating the relationship between said variables for said manipulated variables determined or calculated at the time in said environmental state at the time with representative data stored in said database in the course of controlling said qualities for a specific level, and wherein the step of obtaining said new manipulated variables is a step of obtaining said new manipulated variables after the data in said database is corrected based on the data indicating the relationship between said variables in said environmental state at the time when necessary.

Using the structure described above, for example, with regard to the image density, which is one of the qualities, for controlling the image density for a specific target level by obtaining a control rule as a reference near the target density in the current environmental state and adjusting the manipulated variables for optimum in the current environmental state according to the obtained control rule, the control rule is obtained by defining a control rule plane (image density plane) presenting the control rule. In such a case, when the values of the manipulated variables that are control parameters of the image density or a controlled variable are calculated and the calculated values of the manipulated variables are out of the manipulation available range in the course of obtaining new manipulated variables adjusted for controlling the image density quality for a specific level, the data in the database that are used for comparison to obtain the new values of the manipulated variables are corrected using the detected densities of the formed density patches and then the output image control method repeats the calculation, whereby the image density level can be controlled using optimized parameters without control failure.

The control rule obtained using the patches formed as described above predicts points on the line of intersection between the control rule plane and the target density plane that is a set of points for realizing the target density. Therefore, with the control rule plane being defined using the patches, the dissociation between the control rule plane and the actual apparatus characteristics is prevented. Consequently, the image density can be controlled in a more stable manner. Furthermore, fluctuations in state quantities are less influential. Therefore, it is unnecessary to collect a number of control cases while the apparatus is in operation.

As described above, the output image control method can control the output image quality of the apparatus for a target level in a stable manner.

In another aspect of the present invention provided is a machine readable medium bearing an output image control program for causing the apparatus to execute the steps of the output image control method.

With this structure, the output image control method can be realized through software processing on a computer or a built-in device.

An image forming apparatus that is an image output apparatus according to an embodiment of the present invention is described in detail hereafter with reference to the drawings.

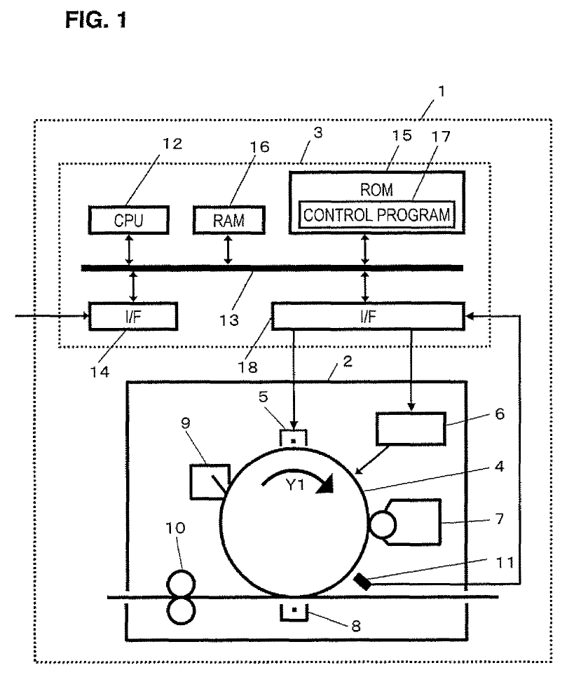

FIG. 1 is a schematic illustration showing the structure of an image forming apparatus according to an embodiment of the present invention.

In FIG. 1, an image forming apparatus 1 comprises an image forming unit 2 and an image density control unit 3. The image forming unit 2 is a mechanism for forming monochrome images according to input image signals on paper through the electrophotographic process. The image forming unit 2 comprises a photo conductor drum 4 that rotates on its axis in the direction Y1 and, around the photo conductor drum 4, a scorotron electrifier (also simply termed an electrifier) 5, a laser output unit 6, a developing unit 7, a transfer unit 8, and a cleaner 9. A fixer 10 is provided on the path along which the paper is conveyed.

For forming an image, the scorotron electrifier 5 that is an electrifier of the scorotron type having a grid electrode and the grid voltage of which is set by the image density control unit 3 described later uniformly charges the surface of the photo conductor drum 4 at a charging rate according to the grid voltage.

The laser output unit 6 having a variable laser power irradiates the uniformly charged surface of the photo conductor drum 4 with a laser beam of which the laser power is set by the image density control unit 3 described later and modified according to the image signals. With this irradiation, an electrostatic latent image according to the image signals is formed on the surface of the photo conductor drum 4.

The developing unit 7 develops the electrostatic latent image on the surface of the photo conductor drum 4 by providing toner adhering to the electrostatic latent image using a developing roller. Here, the developing unit 7 is a two-component developing unit and uses a mixture of toner and a magnetic carrier as developer. The toner is charged as the developer is stirred within the developing unit 7. Only the charged toner adheres to the electrostatic latent image. Then, a visible toner image is formed on the surface of the photo conductor drum 4 (the image formed in this way is a formed image). The image density is affected by the toner-carrier mixture ratio, which is changed as a result of the toner consumption. Therefore, the toner is refilled according to the consumption when necessary.

The transfer unit 8 transfers the toner image on the surface of the photo conductor drum 4 to paper. The cleaner 9 removes residual toner on the surface of the photo conductor drum 4. The fixer 10 fixes the transferred toner image on the paper.

The image forming unit 2 further comprises an image density sensor (also simply termed a sensor) 11. The image density sensor 11 is provided between the developing unit 7 and the transfer unit 8 and faces the surface of the photo conductor drum 4, thereby detecting the density of a toner image formed on the surface of the photo conductor drum 4.

The image density control unit 3 is a control device for controlling the density of a toner image (an output image) (the image density) formed on the surface of the photo conductor drum 4 using values detected by the image density sensor 11. As shown in the figure, the image density control unit 3 comprises a CPU (microprocessor) 12 and a bus 13.

The CPU 12 is connected to an I/F circuit 14, a ROM (read only memory) 15, and a RAM (read/write memory) 16 via the bus 13. The I/F circuit 14 is an interface circuit for communication between the CPU 12 and other not-shown control devices of the image forming apparatus 1. The ROM 15 stores an output image control program (also simply termed a control program) 17.

The control program 17 consists of codes of instructions programmed for giving necessary orders to the image forming unit 2 to control the density of the output image by CPU 12, processing data such as detected values, and performing other procedures and controls. When the image forming apparatus 1 itself is powered on, the CPU 12 first reads the control program 17 (codes) from the ROM 15, extends the control program 17 (codes) on the RAM 16, and executes the procedures according to the instructions of the program to operate the image forming apparatus 1. During the operation, the CPU 12 communicates with other control devices via the I/F circuit 14 when necessary and controls the image density according to the instructions of the control program 17.

A second I/F circuit 18 is also connected to the bus 13. The CPU 12 obtains detected values from the image density sensor 11 and supplies the grid voltage value or the laser power value to the electrifier 5 or the laser output unit 6 via the second I/F circuit 18 during the image density control.

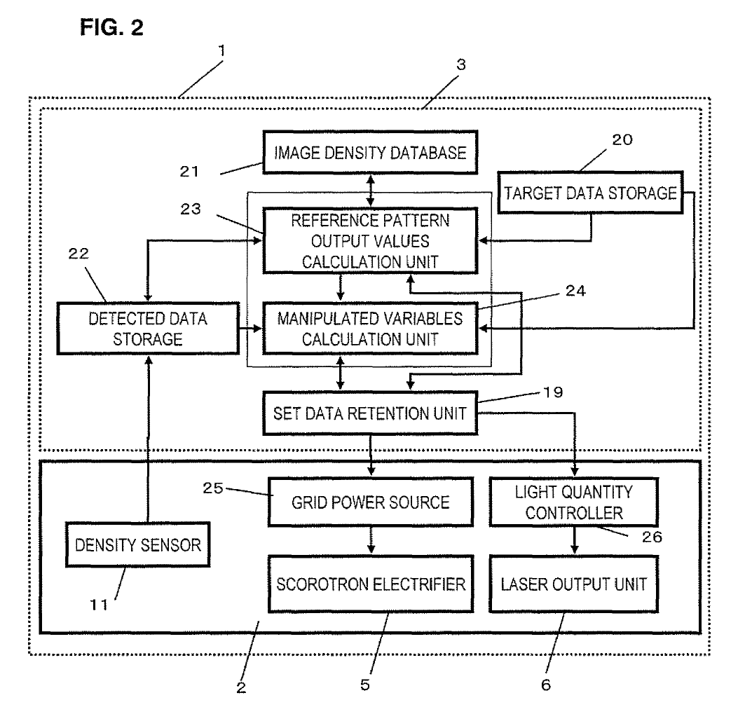

FIG. 2 is a block diagram for explaining functional structures regarding the image density control of the image forming apparatus 1 according to this embodiment.

In FIG. 2, the image density control unit 3 of the image forming apparatus 1 that operates according to the instructions of the control program 17 comprises a set data retention unit 19, a target data storage 20, an image density database 21, a detected data retention unit 22, and a reference pattern output values calculation unit 23 and a manipulated variables calculation unit 24, which are a manipulated variables adjustment unit.

The set data retention unit 19 retains the set value of the grid voltage applied to the scorotron electrifier 5 (“the set value” in this specification is particularly a value indicating a degree of level or magnitude of a manipulated variable and indicates a relative quantity retained in the set data retention unit 19) and the set value of the laser power of the laser output unit 6 until the next time they are supplied and updated by the CPU 12.

As shown in FIG. 2, the electrifier 5 is connected to the image density control unit 3 via a grid power source 25 and the laser output unit 6 is connected to the image density control unit 3 via a light quantity controller 26. The grid power source 25 applies a voltage according to the set value obtained from the set data retention unit 19 to the grid of the electrifier 5. The light quantity controller 26 manipulates the laser power of the laser output unit 6 according to the set value obtained from the set data retention unit 19. In this way, the image density control unit 3 controls the image density using the grid voltage and laser power as manipulated variables in this embodiment.

The target data storage 20 stores the density of a density patch that are a reference pattern as a specific target level of the image density (this density as a target is termed the target density). The data can be set in the apparatus for example by previously writing the target density in the ROM 15. Alternatively, an operator can specify the target density using an operation dial, thereby setting the specified value in the apparatus.

The image density control unit 3 compares the value detected by the image density sensor 11 for an output image of a reference pattern (density patch) at the time with the target density stored in the target data storage 20 for subsequent control of the image density. In this embodiment, the density patch of a reference pattern includes a patch presenting a solid density and a patch presenting a highlight density. The reason that two manipulated variables (the grid voltage and the laser power) described above are used is that the solid and highlight densities of the image density are highly correlated with these manipulated variables. Therefore, the target densities are prepared for both patches, respectively.

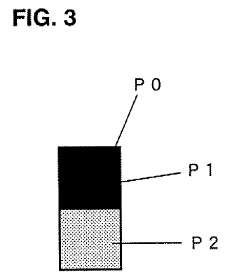

FIG. 3 is an illustration showing an example of the above described reference pattern (density patch). In FIG. 3, the reference pattern P0 consists of a rectangular solid density patch P1 and a rectangular highlight density patch P2. In this figure, the solid density patch P1 and highlight density patch P2 are vertically arranged in this order.

Again referring to FIG. 2, the image density database 21 stores data giving the relationship between the controlled variables of the image forming apparatus 1 that are controlled by the image density control unit 3 (the image density in this embodiment) and the manipulated variables (a set of manipulated variables consisting of a combination of the grid voltage and the laser power in this embodiment. “The grid voltage and the laser power” is referred to for clearly indicating the set of manipulated variables in this specification) with regard to the reference pattern in an appropriate environmental state for controlling the image density (the relationship between the controlled variables and the manipulated variables is termed the control rule). The data (for example, data obtained using a representative machine) can be previously stored in the ROM 15 before the apparatus is operated (for example before shipped from a factory where the apparatus is manufactured). Here, the data consist of records each containing a collection of data in which controlled variables are associated with manipulated variables for each manipulated variable. The image density database 21 has multiple such records over the manipulated variable range and is stored in the ROM 15 in the form of a table of which each row includes one record.

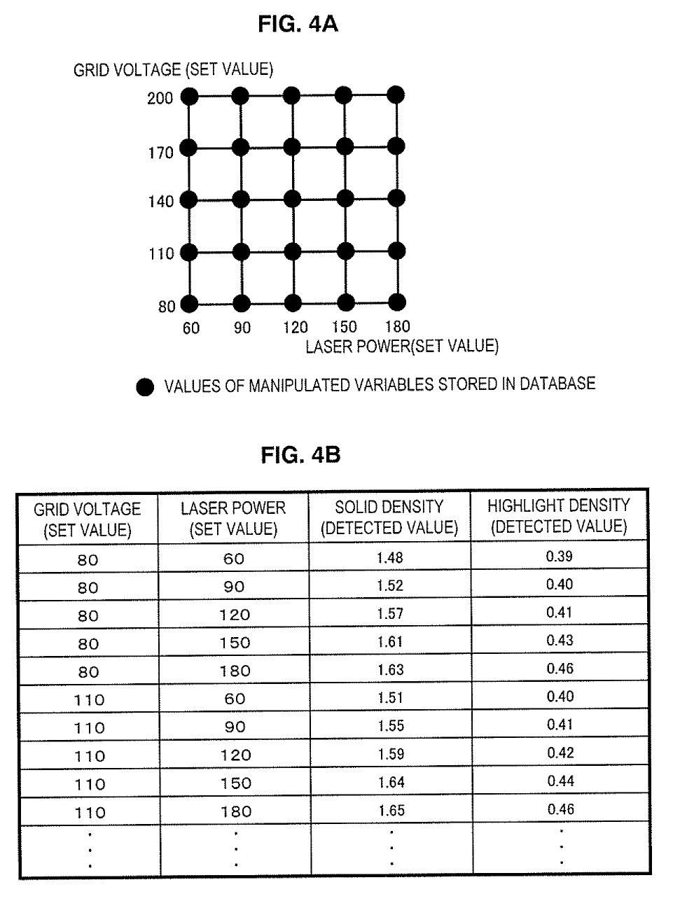

FIG. 4 is an illustration for explaining an exemplary structure of the image density database 21.

FIG. 4A shows a plane constituted by two manipulated variables (the grid voltage and the laser power). The laser power is plotted on the abscissa and the grid voltage is plotted on the ordinate. The lattice points (filled circles) on the plane indicate the positions on the plane corresponding to the manipulated variables (the grid voltage and the laser power) of each record in the image density database 21.

FIG. 4B shows the data structure (two-dimensional arrangement (table)) of the image density database 21 and specific contents (values) in each record constituting a row of the table. Two image densities for the solid density patch P1 and highlight density patch P2 are correlated with two manipulated variables (the grid voltage and the laser power) in each record. Here, the values (units) are relative quantities from the set data retention unit 19 (set values) or the density sensor 11 (detected values).

Again referring to FIG. 2, the reference pattern output values calculation unit 23 as a part of the manipulated variables adjustment unit calculates multiple (at least two) sets of manipulated variables (the grid voltage and the laser power) with which the values of the controlled variables (the density of the output image in the reference pattern (density patches)) are close to the target densities in the current environmental state when the image forming apparatus 1 controls the image density for a specific level.

In other words, for controlling the image density for a specific target level, the image forming apparatus 1 obtains a control rule as a reference near the target densities in the current environmental state and adjusts the manipulated variables for optimum in the current environmental state according to the obtained control rule. The control rule is obtained by defining a control rule plane representing the control rule (a plane formed by plotting the controlled variables in relation to the manipulated variables in a space having coordinate axes for the components of the control rule (termed the image density space), which should be flat and also termed the image density plane). Here, the reference pattern output values calculation unit 23 calculates at least two sets of manipulated variables other than a set consisting of the current set values of the manipulated values among at least three sets of manipulated and controlled variables defining the plane.

The reference pattern output values calculation unit 23 is capable of reading/writing in the set data retention unit 19 and a detected data storage 22 described later. The reference pattern output values calculation unit 23 reads the current values of the manipulated valuables in the set data retention unit 19 and stores them along with the detected densities associated with these manipulated variables in the set data retention unit 19 when the control of the image density for a specific density is started (this point of time is termed “current” for convenience).

The reference pattern output values calculation unit 23 gives the calculated values of the manipulated valuables to the set data retention unit 19 and the image forming apparatus 1 forms images using these manipulated variables.

In this embodiment, the reference pattern output values calculation unit 23 calculates two sets of values of two manipulated variables (the grid voltage and the laser power) for the image forming apparatus 1 to form the solid density patch P1 and highlight density patch P2 shown in FIG. 3 on the surface of the photo conductor drum 4. One set is the values of the manipulated variables (the grid voltage and the laser power) for approximating the density of the solid density patch P1 to the target density among the patches P1 and P2 to be formed. The other set is the values of the manipulated variables (the grid voltage and the laser power) for approximating the density of the highlight density patch P2 to the target density.

The reference pattern output values calculation unit 23 refers to the image density database 21 based on the target densities for the respective patches P1 and P2 to obtain the values of the manipulated variables having the image density close to the target density.

The reference pattern output values calculation unit 23 starts the calculation with obtaining the target densities for the patches P1 and P2 from the target data storage 20. Then, after obtaining the target densities, the reference pattern output values calculation unit 23 obtains from the image density database 21 the values of the manipulated variables with which the image densities corresponding to (close to) the target densities are associated.

Here, there may be some individual difference between the representative machine used for creating the image density database 21 and the actual machine; however, the representative machine and actual machine basically share the same characteristics. For example, obtaining the values of the manipulated variables yielding the image density close to the target density with reference to data in the image density database 21 based on the target density for the solid density patch P1, the image forming apparatus 1 manipulates the image forming characteristics using these manipulated variables and controls the image density to form a solid density patch P1 basically having a density close to the target density. The same is true for the highlight density patch P2.

The detected data storage 22 combines values detected by the image density sensor 11 with the values of the manipulated variables at the time of the detection and stores at least three sets of them. In order for the image forming apparatus 1 to control the image density for a specific level, the image forming unit 2 forms the solid density patch P1 and highlight density P2 on the surface of the photo conductor drum 4 and the image density control unit 3 detects the densities of the patches P1 and P2 using the image density sensor 11. Then, the detected data storage 22 stores at least three sets of the detected values for the patches P1 and P2 and the values of the manipulated variables (the grid voltage and the laser power) used in forming the patches P1 and P2.

Among them, two sets are data regarding the values of the manipulated variables (the grid voltage and the laser power) calculated by the reference pattern output values calculation unit 23.

The remaining one set is data regarding the current set values of the manipulated variables (the grid voltage and the laser power) retained in the set data retention unit 19 when the control of the image density for a specific level is started. The image density control unit 3 stores the current set values of the manipulated variables and the detected densities of the patches P1 and P2 formed by the image forming apparatus 1 using these set values in the detected data storage 22 when the reference pattern output values calculation unit 23 calculates the values of the manipulated variables for obtaining the control rule described above.

In order for the image forming apparatus 1 to control the image density for a specific level, the manipulated variables calculation unit 24 as a part of the manipulated variables adjustment unit calculates the values of the manipulated valuables adjusted for the output image density of the apparatus 1 being a target level based on the detected densities of multiple images of the reference pattern formed using the values of the manipulated variables calculated by the reference pattern output values calculation unit 23 and their target values. To this end, the manipulated variables calculation unit 24 performs a procedure to obtain linearly approximate output characteristics in forming images in the image forming apparatus 1 from the detected densities of multiple images of the reference pattern and the values of the manipulated valuables calculated by the reference pattern output values calculation unit 23 and used to form the images.

The prior art image forming apparatus disclosed in the Japanese Laid-Open Patent Application Publication No. H10-63048 obtains linearly approximate output characteristics in forming images in the apparatus by defining a control case plane using three sets of manipulated variables (the grid voltage and the laser power) extracted based on the current state quantities among accumulated data of many past control cases. On the other hand, the image forming apparatus 1 of this embodiment does not have such accumulated data and the manipulated variables calculation unit 24 defines a control rule plane using the values of the manipulated variables calculated by the reference pattern output values calculation unit 23.

Operation of the image forming apparatus 1 having the above described structure for controlling the image density for a specific level is described hereafter.

For controlling the image density for a specific level, the image forming apparatus 1 first obtains a control rule (the relationship between the values of the manipulated variables and the values of the controlled variables) in the current environmental state. To do so, the values of the manipulated variables that determine conditions for forming the reference pattern are calculated to form the density patches (reference pattern) and obtain the detected densities thereof in the current environmental state.

First, the calculation of the values of the manipulated variables that determine conditions for forming the reference pattern is described.

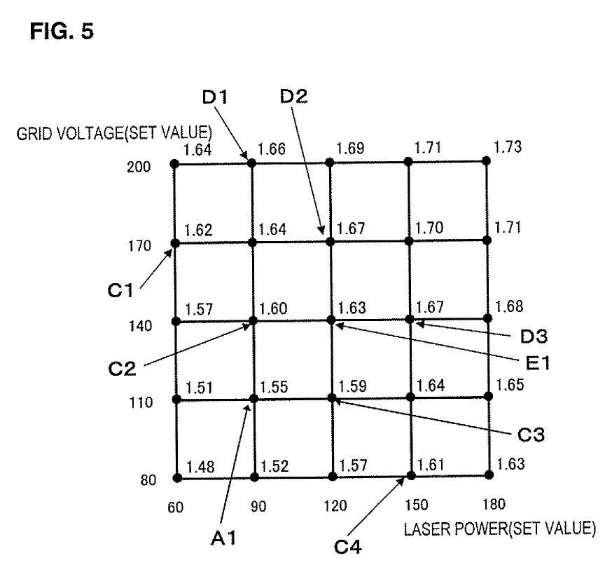

Among the manipulated variables of the image forming apparatus 1, the grid voltage is set for 110 and the laser power is set for 90 at present (the point A1 in FIG. 5 described below). Among the detected values of the controlled variables in the current environmental state, the image density of the solid density patch P1 is 1.54 and the target density thereof is set for 1.60.

FIG. 5 is an illustration showing exemplary values of the image density of the solid density patch P1 stored in the image density database 21 on the plane shown in FIG. 4A. In this figure, the numbers at the upper right of each lattice point indicate the density of the solid density patch P1 in the corresponding record.

Past experiments show that the solid density is more affected by the laser power than by the grid voltage. In other words, when the laser power is changed, the density is changed more in the solid density area than in the highlight density area. Conversely, the highlight density is more affected by the grid voltage than by the laser power. It is very useful in controlling multiple densities such as the solid and highlight densities that different parameters are dominant in specific densities as proved in the past experiments.

In this embodiment, when the image forming apparatus 1 controls the image density for a specific target level, the reference pattern output values calculation unit 23 changes the value of the manipulated variable dominant in the controlled variable by priority among the multiple manipulated variables for adjustment and searches for and obtains the value of the manipulated variable for that adjustment in the image density database 21 (the manipulated variable that is changed by priority for adjustment is termed the priority manipulated variable in a set of manipulated variables consisting of a combination of multiple manipulated variables).

In other words, as described above, the laser power is the most dominant in the solid density among the two manipulated variables (the grid voltage and the laser power). Therefore, the reference pattern output values calculation unit 23 gives priority to a record having a grid voltage equal to its current set value and a laser power different from its current set value when it searches for a record having image densities close to the target values for adjusting the manipulated variables and controlling the image density or a controlled variable for a specific level. For example, among four points C1 through C4 in FIG. 5, only the point C3 has the same grid voltage as the current set value (the point A1) of the manipulated variable. Therefore, a record corresponding to the point C3 is searched for.

The calculation of the values of the manipulated variables according to the above concept is described in detail in sequence hereafter.

First, the reference pattern output values calculation unit 23 obtains the current set values of the manipulated variables retained in the set data retention unit 19 and, then, reads the densities corresponding to the set values in the image density database 21. In other words, the point A1 presents the current set value of the manipulated variable and the reference pattern output values calculation unit 23 reads “1.55” in the image density database 21 as the density at the point A1.

After reading the density in the image density database 21, the reference pattern output value calculation unit 23 compares the density with a value that is the detected density of the solid patch P1 formed by the image forming apparatus 1 using the current set values of the manipulated variables and stored in the detected data storage 22. If the actual detected value is “1.54,” it is smaller than the density read from the database 21 by “0.01.” This difference represents the shift of the current state quantities such as the environmental state from the state quantities when the data in the image density database 21 is obtained.

When the difference between the read value and the actual detected value is not zero, the reference pattern output values calculation unit 23 adds the difference to the target density obtained from the target data storage 20 to yield a corrected target density. Then, the reference pattern output values calculation unit 23 obtains from the image density database 21 the values of the manipulated variables associated with the density corresponding to the corrected target density instead of the target density obtained from the target data storage 20. As described above, if the target density is “1.60” and the actual detected value is smaller than the read value by “0.01,” the corrected target density is “1.59.” In this case, the records having a density close to the corrected target density are also the records corresponding to the four points C1 through C4. Then, the reference pattern output values calculation unit 23 selects the record corresponding to the point C3 and having the same grid voltage as the current set value as described above.

Subsequently, the reference pattern output values calculation unit 23 reads the values of the manipulated valuables from the selected record and uses these values to calculate the values of the manipulated valuables for forming the solid density patch P1. The record corresponding to the point C3 has a density “1.59,” which is equal to the corrected target density described above. When the corrected target density and the density in the record are equal, the reference pattern output values calculation unit 23 simply makes reference to the data in that record and determines the values of the manipulated variables for forming the solid density patch P1. A laser power of “120” and a grid voltage of “110” can be obtained from the record corresponding to the point C3.

In the embodiment described above, a record having the same grid voltage as the current set value is searched for. However, no record having a density corresponding to the target density or the corrected target density may be found among the records having the same grid voltage as the current set value.

In such a case, the reference pattern output values calculation unit 23 gives priority to a record having a smaller difference between the grid voltage value and the current set value. For example, if the target density is “1.67” and the current set values of the manipulated variables and the detected values corresponding to these set values are the same as in the above example, the corrected target density is “1.66.” The corrected target density is larger than “1.65,” which is the maximum value when the grid voltage is not changed from the current set value. Therefore, records having a density close to the corrected target density are the record corresponding to three points D1 through D3. Among them, the record having the smallest difference between the grid voltage value and the current set value is the record corresponding to the point D3.

Subsequently, the reference pattern output values calculation unit 23 compares the density read from the record corresponding to the point D3 with the corrected target density. The density in the record corresponding to the point D3 is “1.67” and the corrected target density is “1.66”; therefore, the corrected target density is smaller than the density in the record by “0.01.”

Here, if the density read from the record is not equal to the corrected target density, the reference pattern output values calculation unit 23 can calculate the values of the manipulated variables by interpolation.

For calculating the values of the manipulated variables by interpolation, the reference pattern output values calculation unit 23 searches for a record in which the density is close to the corrected target density next to the record corresponding to the point D3 among the records having the same grid voltage value as the record corresponding to the point D3. In the embodiment shown in FIG. 5, a record in which the density is close to the corrected target density next to the record corresponding to the point D3 is the record corresponding to the point A1. When that record is found, the reference pattern output values calculation unit 23 reads the density and laser power values not only in the record corresponding to the point D3 but also in the record corresponding to the point A1. The differences in density and laser power between these records are “0.04” and “30,” respectively. The difference between the corrected target density and the density read from the record corresponding to the point A1 is “0.03.” Based on these values, the reference pattern output values calculation unit 23 can calculate a laser power corresponding to the corrected target density of “143.” In this way, the reference pattern output values calculation unit 23 obtains a laser power value of “143” and a grid voltage value of “140.”

As described above, the reference pattern output values calculation unit 23 can calculate the values of the manipulated variables for matching the density of the solid density patch P1 with the solid density target value. The values of the manipulated variables for matching the density of the highlight density patch P2 with its target value can be similarly calculated.

Output image control steps including the steps to calculate the values of the manipulated variables described above are described hereafter.

For controlling the image density for a specific level, the image forming apparatus 1 comprising the image density control unit 3 executes the steps of the output image control method as described below according to instructions of the control program 17, thereby realizing the functions to calculate the values of the manipulated variables that determine conditions for forming the reference pattern as described above and to calculate the values of the manipulated variables adjusted for matching the output image density with its target level.

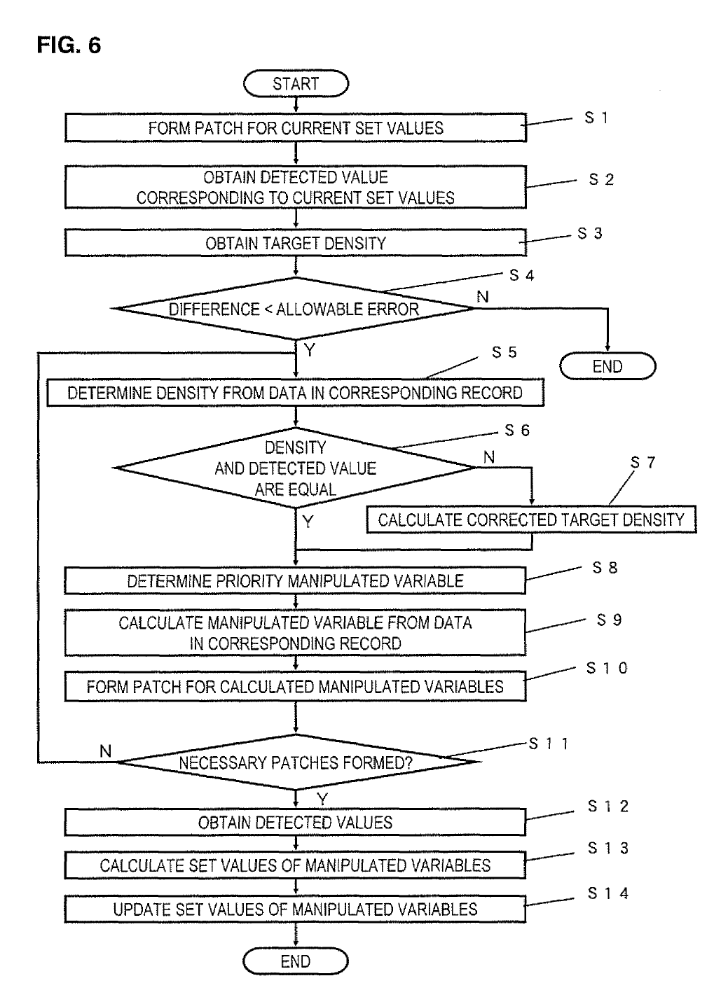

FIG. 6 is a flowchart for explaining the steps of the output image control method for controlling the image density for a specific level in this embodiment.

In FIG. 6, the image density control unit 3 of the image forming apparatus 1 starts the control with an operator command, an order from a remote place, or self-diagnosed results. With the control being started, the image forming apparatus 1 forms a sold density patch P1 and a highlight density patch P2 on the surface of the photo conductor drum 4 using the current set values of the manipulated variables retained in the set data retention unit 19 (Step S1). After the patches P1 and P2 are formed, the image forming apparatus 1 detects the densities of the patches P1 and P2 using the image density sensor 11. After the densities of the patches P1 and P2 are detected, the image density control unit 3 stores the current set values of the manipulated variables and the detected densities (these data present the control rule for the current set values of the manipulated variables in the current environmental state) in the detected data storage 22.

Then, the image density control unit 3 obtains the current set values of the manipulated variables from the detected data storage 22 and the corresponding detected densities (Step S2). It also obtains the target densities for the patches P1 and P2 from the target data storage 20 (Step S3).

Then, obtaining the detected values and target densities, the image density control unit 3 determines whether the differences between the detected values and the target values are within an allowable range (Step S4).

If the differences are within the allowable range, the image density control unit 3 ends the control process.

On the other hand, if the differences are not within the allowable range, the image control unit 3 calculates the values of the manipulated variables for matching the density of either the solid density patch P1 or the highlight density patch P2 with its target density and, then, calculates the values of the manipulated variables for matching the density of the other patch with its target density. Here, the values of the manipulated variables for matching the density of the solid density patch P1 with its target density are calculated first.

First, the image density control unit 3 searches for a record corresponding to the current set values of the manipulated variables in the image density database 21 and determines the density based on the data in that record (Step S5). If the image density database 21 has a record having the same values of the manipulated variables as the current set values, the density of the solid density patch P1 is read from that record. On the other hand, if there is no record having the same values of the manipulated variables as the current set values, the density is determined by interpolation using data in four records.

After the density is determined, the image density control unit 3 determines whether the density determined using data in the image density database 21 and the detected value for the solid density patch P1 are equal (Step S6). If the determined density and the detected value are not equal, the image density control unit 3 calculates a corrected target density (Step S7).

After the determined density and the detected value are found to be equal or a corrected target density is calculated, the image density control unit 3 determines the priority manipulated variable (Step S8).

In Step S8, for calculating the values of the manipulated variables for matching the density of the solid density patch P1 with its target density, the laser power is selected as the priority manipulated variable among the grid voltage and the laser power as described above. Furthermore, for calculating the values of the manipulated variables for matching the density of the highlight density patch P2 with its target density, the grid voltage is elected as the priority manipulated variable to execute this procedure.

After the priority manipulated variable is selected, the image density control unit 3 selects a record giving a larger change in the priority manipulated variable and a smaller change in the other manipulated variable among the records corresponding to the target density or the corrected target density. After the record is selected, the values of the manipulated variables are read from the data in that record to determine the values of the manipulated values for matching the density of the solid density patch P1 with the solid density target value (Step S9). When the density of the solid density patch P1 in the record selected is equal to the target density or the corrected target density, the data are simply read from the record to obtain the values of the manipulated variables. On the other hand, when they are not equal, the values of the manipulated variables can be calculated by interpolation.

After the values of the manipulated variables are calculated, the image forming apparatus 1 forms a solid density patch P1 on the surface of the photo conductor drum 4 using the calculated values of the manipulated variables (for manipulating the grid voltage and the laser power) (Step S10) and detects the density of the formed solid density patch P1 using the image density sensor 11. When the density of the formed solid density patch P1 is detected, the image density control unit 3 stores the calculated values of the manipulated variables and the detected density for these manipulated variables (the data presents the control rule of the values of the first manipulated variables calculated in the current environmental state) in the detected data storage 22.

In this way, the data presenting the control rule in the current environmental state is stored in the detected data storage 22. Then, the image density control unit 3 determines whether the image forming apparatus 1 forms all necessary patches (Step S11).

Here, if only a patch corresponding to the solid density target value is formed, the image density control unit 3 determines that the image forming apparatus 1 has not formed all necessary patches. In such a case, the image density control unit 3 repeats the steps S5 through S11 to calculate the values of the manipulated variables for matching the density of the highlight density patch P2 with its target density so that the image forming apparatus 1 forms a patch corresponding to the highlight density target value (Consequently, the detected data storage 22 stores data presenting the control rule for the values of the second manipulated variables calculated in the current environmental state).

On the other hand, if it is determined that the image forming apparatus 1 has formed all necessary patches, the image density control unit 3 obtains from the detected data storage 22 data presenting the control rules for the current set values and data presenting the control rules for the two calculated values (the calculated values of the first and second manipulated variables) (Step S12).

Then, the image density control unit 3 calculates the values of the manipulated variables based on the target density data for the patches P1 and P2 and the data presenting their control rules obtained from the detected data storage 22 (Step S13).

In the calculation of the manipulated variables, as described above, the manipulated variables calculation unit 24 executes the procedure to obtain linearly approximate output characteristics in forming images in the image forming apparatus 1 based on the detected densities of multiple images in the reference pattern and the values of the manipulated variables used for forming the images.

In other words, when the solid density patch P1 and highlight density patch P2 are formed using the values of the manipulated variables calculated by the reference pattern output values calculation unit 23, at least one of the batches has a density close to its target value. The manipulated variables calculation unit 24 defines a control rule plane for the solid and highlight densities using their detected densities and calculated values of the manipulated variables. The manipulated variables calculation unit 24 obtains the line of intersection between the solid density control rule plane and the solid density target density plane and the line of intersection between the highlight density control rule plane and the solid density target density plane. After the lines of intersection for the solid and highlight densities are obtained, the manipulated variables calculation unit 24 obtains an intersection point between the two lines of intersection projected on a plane constituted by multiple manipulated variables to yield the values of the manipulated variables corresponding to the target values.

Then, the image density control unit 3 sets the calculated values of the manipulated variables in the set data retention unit 19 so as to update the set values of the manipulated variables (Step S14).

The operation to calculate the values of the manipulated variables that determine conditions for forming the reference pattern and calculate the adjusted values of the manipulated variables is described above. Here, if the calculated values of the manipulated variables are within the controllable range, in other words, the grid voltage and laser power values are within the manipulation available range, the adjusted values of the manipulated variables can be applied to the image forming apparatus 1 as they are. However, they may be out of the manipulation available range in some cases. This tends to occur when there are large differences between image density characteristics of a representative machine stored in the image density database 21 and image density characteristics of an actual machine in some environmental state. The calculated values out of the manipulation available range are not applied to the manipulated variable, thereby leading to control failure.

In such a case, the calculation procedure described above can be repeated to recalculate the values of the manipulated variables that do not lead to control failure. However, the same calculation results are obtained if the same data are used. Then, the image density control unit 3 of this embodiment of the present invention corrects the database in the image density database 21 using the detected densities of density patches formed by the image forming apparatus 1.

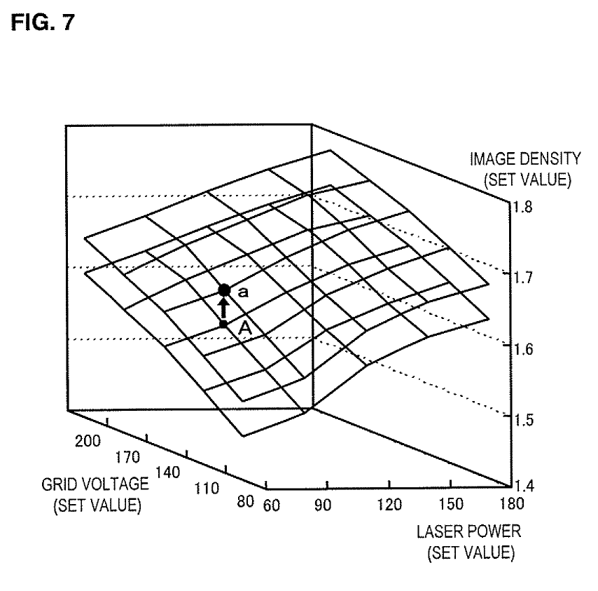

Modification and correction of the database stored in the image density database 21 is described with reference to illustrations in FIGS. 7 through 9 showing image density spaces for explaining the database correction procedure.

For correcting the database, with regard to three manipulated variables used by the image forming apparatus 1 to form a density patch image, the detected density data of the density patch and the set values of the manipulated variables at the time are used.

In FIGS. 7 through 9, among three manipulated variables, a point (manipulated variables) having the smallest difference between the detected density data of the density patch and the density data for the manipulated variables in the image density database 21 is selected. Here, the density data of the density patch is designated by a point a and the density data in the image density database 21 is designated by a point A. The point A is shifted along the image density axis to coincide with the point a (FIG. 7). In other words, the difference Dd1 between the points A and a is added to all density data in the table. Consequently, the point a coincides with the point A.

Then, the image density database 21 is corrected so that the remaining two points coincides.

First, among three points for which the density patch is formed, the point having a laser power set value more different from that at the point a is designated as a point b. The density data in the image density database 21 for the set value at the point b is designated by a point B. Here, the grid voltage set value and the laser power set value at the point a (the point A) are Vga and Lpa and the image density for these values is Da. Similarly, the grid voltage set value and the laser power set value at the point b are Vgb and Lpb and the image density for these values is Db. In addition, the image density at the point B is DB.

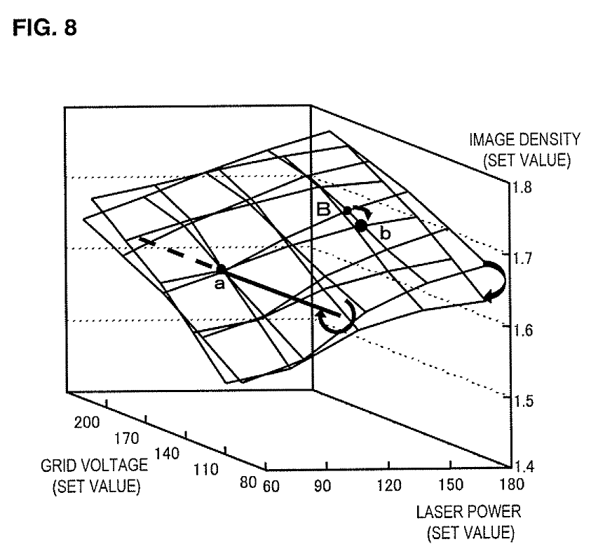

In order for the plane presenting image density characteristics exhibited by the image density database 21 to be in contact not only with the point a but also with the point b, it is rotated about a line presenting the grid voltage set values Vga and image density Da at the point a so that it is linearly transformed to be in contact with the point b (FIG. 8). A correction value Dd2 added to the imaged density database 21 is given by the following equation in which Lpx is the laser power set value at the point:

$$Dd 2 = \frac{( Db - DB )}{( Lpb - Lpa )} ( Lpx - Lpa ) \qquad [ Math 1 ]$$

By calculating the correction value Dd2 for each point of the image density database 21 and adding it to the value at each point, a plane presenting image density characteristics becomes in contact with the points a and b.

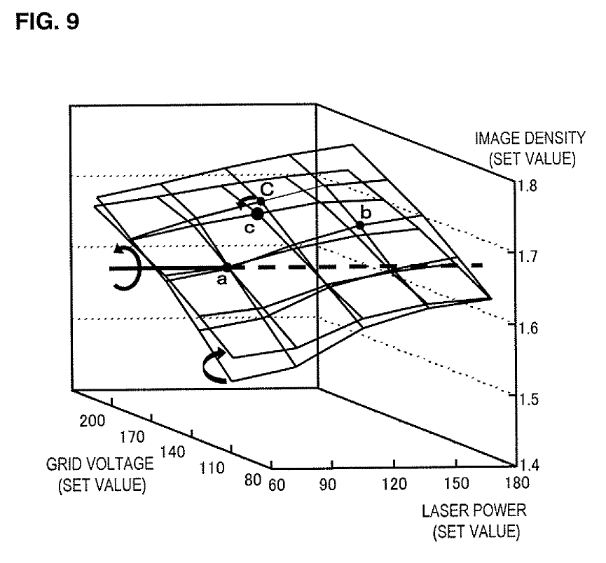

Furthermore, in order for the plane presenting image density characteristics to be in contact with the remaining point c in addition to the points a and b, it is rotated about an axis perpendicular to the rotation axis in FIG. 8 (the line presenting the laser power set value Lpa and image density Da) (FIG. 9). Here, the density data in the image density database 21 for the set value at the point c is designated by a point C. The grid voltage set value is Vgc, the laser power set value is Lpc at the point c, and the image density for these values is Dc. In addition, the image density at the point C is DC. A correction value Dd3 added to the image density database 21 is given by the following equation in which Vgx is the grid voltage set value at the point:

$$Dd 3 = \frac{( Dc - D C )}{( Vgc - Vga )} ( Vgx - Vga ) \qquad [ Math 2 ]$$

Similarly to Dd2, the correction value Dd3 is calculated for each point in the image density database 21 and added to the value at each point so that a corrected image density database (referred to by a reference number 21A for convenience) in which a plane presenting image density characteristics is in contact with the points a, b, and c is created.

A method for predicting a laser power set value and a grid voltage set value yielding the solid and highlight target densities using the corrected image density database 21A obtained as described above is described hereafter.

The prediction method calculates and determines a point where the solid density is satisfied by changing only the laser power and a point where the highlight density is satisfied by changing only the grid voltage in the same manner as the first prediction method described above. The image forming apparatus 1 forms solid and highlight density patches using the calculated set values for the two points and detects them using the image density sensor. Using the detection results for the two points and detection result for the current set values, the image density control unit 3 again defines an image density plane and calculates the laser power set value and grid voltage set value that satisfy both the solid target density and the highlight target density.

In this way, the prediction can be done using the corrected image density database 21 suitable for the current environmental state; therefore, the image density control unit 3 can control the image density without control failure.

The image density control unit 3 uses the corrected image density database 21A in the subsequent image density control (the image density database 21 is updated). However, when the developing unit 7, photo conductor drum 4, or other process cartridges are found to be replaced, the image density database 21 is initialized to the initial state (data formed using a representative machine at a factory where the apparatus is manufactured). The image density database 21 can be initialized when the apparatus is powered on instead of when a process cartridge is replaced. Alternatively, the updated state can be maintained without the initialization.

As described above, in the control of the image density for a specific target level by obtaining the control rule as a reference near the target density in the current environmental state and adjusting the manipulated variables for optimum in the current environmental state according to the obtained control rule, the control rule is obtained by defining a control rule plane (image density lane) presenting the control rule. In such as case, if the calculated values of the manipulated variables are out of the manipulation available range, the database stored in the image density database 21 is corrected using the detected densities of the formed density patches, whereby the image density control unit 3 according to this embodiment of the present invention can control the image density level without control failure.

The control rule obtained using the patches formed as described above predicts points on the target-achieving line that is a line of intersection between the control rule plane and the target density plane. Therefore, with the control rule plane being defined using the patches, the dissociation between the control rule plane and the actual apparatus characteristics is prevented. Then, the image density can be controlled in a more stable manner. In addition, fluctuations in state quantities are less influential; therefore, it is unnecessary to collect many control cases while the apparatus is in operation.

With regard to the order in which the image density database 21 coincides with three density patch detection points, in this embodiment, the point a is a point having the smallest difference between the detected image density of the density patch and the value in the image density database 21 corresponding to the set value, the point b is a point having a laser power set value more different from that of the point a among the remaining two points, and the remaining point is the point c. Then, the points a, b, and c are coincided in this order. However, the points are not necessarily chosen as described above. The point a can be a point that is the closest to the mid-points of the manipulation available ranges of the laser power set value and grid voltage set value. The axis for coinciding with the second point can be the line along which the laser power set value is constant instead of the line along which the grid voltage set value is constant. Furthermore, the points a, b, and c can be randomly selected for easier processing.

As described above, it is preferable in the electrophotographic process to use two reference patterns: a reference pattern for matching the solid density patch P1 with its target value and a reference pattern for matching the highlight density patch P2 with its target value. This is because many factors changing the image density are associated with each other in a complex manner in the electrophotographic process. Therefore, changes in characteristics in the solid and highlight density regions are not always correlated to each other. Generally, the image density is increased as the temperature or humidity becomes higher in the surrounding environment. Conversely, the image density is reduced as the temperature or humidity becomes lower. However, characteristics are not always similarly changed in different density regions due to factors such as deterioration of the components and carrier. Therefore, it is preferable to use a reference pattern for matching the solid density patch P1 with its target value and a reference pattern for matching the highlight density patch P2 with its target value in addition to a reference pattern corresponding to the current set values.

In the embodiment described above, the image density control unit 3 corrects the data stored in the image density database 21 and controls the image density level using the corrected image density database 21A obtained after the correction. Therefore, the image density level can be controlled even if the apparatus components are subject to relatively slow changes over time or in a continued manner and new manipulated variables become out of the manipulation available ranges because of accumulation of such changes.

However, new manipulated variables become out of the manipulation available ranges due to rapid changes of the environmental state in which the apparatus is placed. For example, the apparatus is temporarily placed in an environment with temperatures much lower than usual. When the data stored in the image density database is updated according to the environmental state in such a case, it may be difficult to properly control the imaged density level when the surrounding environment of the apparatus is returned to the normal environment. Therefore, after correcting the data read from the image density database 21, the image density control unit 3 can temporarily store the corrected data in another memory region and control the image density level using the temporarily stored data without updating the data stored in the image density database 21. Since the data stored in the image density database is not updated with the corrected data, a temporal and unusual environment as described above can be handled and inconveniences after the normal environment is back can be prevented.

The setting as to whether or not the data stored in the image density database is corrected and the setting as to in which the corrected data is written into the image density database or another temporal memory region, can be prepared so that the apparatus operates based on the settings. These settings can be selected by the user or automatically by the image density control unit 3. For example, the image density control unit 3 corrects the data read from the image density database 21 and uses the setting of writing the corrected data in the image density database as a default setting. The image density control unit 3 displays the current setting on a display to inform the user of it through communication via the interface 14. The user confirms the current setting displayed on the display and determines whether or not he/she switches the setting based on the surrounding environment and his/her past experience. Receiving the user operation for selecting either the setting of not correcting the data stored in the image density database or the setting of writing the corrected data in a temporary memory region, the image density control unit 3 switches the setting according to the operation.

Furthermore, the image density control unit 3 can switch the setting based on the environmental state such as temperature and humidity. The environmental state can be detected using a sensor or determined according to the date and time at the time. For example, when the detected temperature is lower than the temperature when the data stored in the image density database 21 is obtained by a predetermined threshold or more, the image density control unit 3 writes the corrected data in a temporal memory region and does not update the data in the image density database 21 as described above. When the environmental state is restored, the image density control unit 3 switches the setting and writes the corrected data in the image density database 21 to update the data.

Even if the external environment such as temperature and humidity is not changed, the environmental state can be changed because of changes over time in performance characteristics of the apparatus as described above. Therefore, the image density control unit 3 obtains the difference between the data stored in the image density database 21 and the data in the environment at the time and changes the setting based on the difference even if the external environment is within a certain range. For example, if such a difference exceeds a given quantity, the image density control unit 3 uses the setting of writing the corrected data in the image density database 21 so as to update the image density database 21.

With the settings being changed as described above when necessary, the image density database is not updated in an unusual environmental state for consistent control while it is updated in association with slow changes over time of the apparatus, thereby realizing the control according to the current performance characteristics of the apparatus. In other words, the image density database is not unnecessarily updated and is updated when necessary.

In the embodiment described above, two manipulated variables, the grid voltage of the electrifier 5 and the laser power of the laser output unit 6, are used. However, they are not restricted. For example, in addition to them, the developing bias voltage of the developing unit 7 can be used as a manipulated variable. Here, the relationship between the charging bias voltage of the electrifier 5 and the developing bias voltage of the developing voltage affect toner fogging and carrier blasting in case of a two-component developing unit. When the difference between the charging and developing bias potentials is excessively small, fogging occurs in which toner adheres over the entire printed letters. Conversely, when the difference is excessively large, carrier blasting occurs in which the carrier within the developing unit 7 blasts out. Then, if the developing bias voltage is fixed, the setting range of the charging bias voltage is automatically determined. In addition, with the inclusion of margins in consideration of fluctuations in the environmental state, the setting range is further limited. Such a limitation can be dissolved by using both the charging bias voltage and the developing bias voltage as manipulated variables.

In the embodiment described above, the present invention is applied to an apparatus forming monochrome images. However, the present invention is not restricted thereto. The present invention can be applied to an apparatus forming color images. In color images, a single unstable color density affects the overlapped color tone. Therefore, it is essential to stable the densities through the control as described above in forming color images. The densities of respective color toner images can be controlled as described above in a so-called tandem type image forming apparatus in which yellow, cyan, magenta, and black image forming units are arranged in a row. Furthermore, if the tandem type image forming apparatus has an intermediate transfer member for overlapping toner images of the respective colors, the density of a toner image on the intermediate transfer member can be detected. In such a case, it is unnecessary to prepare the density sensor 11 for each color. In this way, the number of the density sensor 11 is reduced and so does the cost.

In addition to the grid voltage of the scorotron electrifier 5, laser power of the laser output unit 6, and developing bias voltage of the developing unit 7, the on-time of signals corresponding to the pixel width in image signals supplied to the laser output unit 6 (so-called the pulse width) and other density-related factors can be used as manipulated variables. In other words, three or more manipulated variables can be used.

Instead of controlling the toner image density, the density of an output image formed by printing an image on an output medium such as paper (a printed image) can be controlled. In such a case, a density sensor for detecting the density of a fixed image as a detection unit for detecting the output image density (controlled variable) can be provided in the image forming unit 2.

The controlled variable is not restricted to the image density. Other image-related quantities such as brightness, hue, and gloss can be controlled as described above.

In the embodiment described above, the present invention is applied to an electrophotographic image forming apparatus. However, the present invention is not restricted thereto. The present invention can be applied to an inkjet and other image forming apparatus and an image display apparatus such as a display. The present invention can also be applied to a system in which an image forming apparatus and/or an image display apparatus and a computer are connected.

The control program 17 used in the embodiment described above can be provided to related parties and/or third parties through electric communication lines such as Internet or by storing it in a computer readable recording medium. For example, the program instructions are expressed by electric, optical, or magnetic signals and the signals are transmitted in carrier waves, whereby the program can be provided through transmission media such as coaxial cables, copper wires, or optical fibers. Usable computer readable recording media include optical media such as CD-ROM and DVD-ROM, magnetic media such as flexible discs, and semiconductor memories such as flash memories and nonvolatile RAM.

The image output apparatus, output image control method, and output image control program of the present invention allows a stable control of the output image quality for a specific level without collecting many control case data while the image output apparatus is in operation and can be used as an image output apparatus in image forming apparatuses such as electrophotographic and inkjet copy, facsimile, printer, and multifunction peripheral and other information processing systems.

This application claims convention priority from Japanese patent application No. 2006-007089, filed Jan. 16, 2006 which is hereby incorporated by reference.

What is claimed is:

1. An image output apparatus for outputting an image, the apparatus having a function to manipulate characteristics regarding qualities including an optical density of the image outputted by the apparatus through adjustment for controlling the qualities for a specific level in relation to environmental states including an environment in which the apparatus is placed and changes over time in performance characteristics, the apparatus comprising:
a data storage unit configured to store representative data indicating a relationship between manipulated variables and controlled variables for predetermined representative manipulated variables in a specific environmental state, said manipulated variables being variables used for manipulating characteristics regarding said qualities, said controlled variables being indices of said qualities in a reference pattern that is an image used as a reference for obtaining the indices; and
a manipulated variables adjustment unit configured to obtain new manipulated variables adjusted for controlling said qualities for a specific level by comparing the data indicating the relationship between said variables for the manipulated variables determined or calculated at the time in said environmental state at the time with representative data stored in said data storage unit in the course of controlling said variables for a specific level,
and wherein said manipulated variables adjustment unit corrects the data in said data storage unit based on the data indicating the relationship between said variables in said environmental state at the time when necessary in the course of controlling said qualities for a specific level to obtain said new manipulated variables.

2. The image output apparatus of claim 1, wherein said manipulated variables adjustment unit temporarily corrects and uses the data in said data storage unit to obtain said new manipulated variables once again when said new manipulated variables are out of the manipulation available range of the apparatus.

3. The image output apparatus of claim 1, wherein said manipulated variables adjustment unit corrects and updates the data in said data storage unit to obtain said new manipulated variables once again when said new manipulated variables are out of the manipulation available range of the apparatus.

4. The image output apparatus of claim 1, wherein said manipulated variables adjustment unit temporarily corrects and uses the data in said data storage unit or corrects and updates the data in said data storage unit to obtain said new manipulated variables once again when said new manipulated variables are out of the manipulation available range of the apparatus.

5. The image output apparatus of claim 4, wherein the apparatus determines whether the data in said data storage unit is temporarily corrected and used or updated based on said environmental state.

6. The image output apparatus of claim 1, wherein said manipulated variables adjustment unit corrects the data in said data storage unit by linearly transforming the data in said data storage unit based on the relationship between said variables in said environmental state at the time.

7. An image forming apparatus for forming a toner image according to an image signal, the apparatus having a function to manipulate characteristics regarding qualities including an optical density of the toner image formed by said apparatus through adjustment for controlling said qualities for a specific level in relation to environmental states including an environment in which the apparatus is placed and changes over time in performance characteristics, the apparatus comprising:
an electrifier configured to uniformly charge the surface of a photo conductor on which an electrostatic latent image that is an electrostatic image is formed, to a bias voltage of an arbitrary level within a specific range;
a laser output unit configured to form said electrostatic latent image according to the image signal on said photo conductor surface by exposing said uniformly charged photo conductor surface with an arbitrary exposure rate within a specific range;
a developing unit configured to develop said electrostatic latent image on the photo conductor surface using toner at a second bias voltage within a specific range according to said bias voltage of an arbitrary level so as to form said toner image on said photo conductor surface;
a sensor configured to detect the optical density of said toner image formed on said photo conductor surface in a reference pattern, said reference pattern being an image used as a reference for obtaining indices;
a database configured to store representative data indicating a relationship between the values of said bias voltage and exposure rate that are the manipulated variables with said electrifier and laser output unit and the detected density that is a detected value of the optical density of the toner image in said reference pattern used as an index of said qualities for predetermined representative manipulated variables in a specific environmental state; and
a manipulated variables adjustment configured to obtain said manipulated variables adjusted for controlling said qualities for a specific level by comparing the data indicating the relationship between said values for the manipulated variables determined or calculated at the time in said environmental state at the time with representative data stored in said database in the course of controlling said qualities for a specific level,
and wherein said manipulated variables adjustment unit corrects the data in said database based on the data indicating the relationship between said values in said environmental state at the time when necessary in the course of controlling said qualities for a specific level to obtains said new manipulated variables.

8. The image forming apparatus of claim 7, wherein said manipulated variables adjustment unit temporarily corrects and uses the data in said database to obtain said new manipulated variables once again when said new manipulated variables are out of the manipulation available range of the apparatus.

9. The image forming apparatus of claim 7, wherein said manipulated variables adjustment unit corrects and updates the data in said database to obtain said new manipulated variables once again when said new manipulated variables are out of the manipulation available range of the apparatus.

10. The image forming apparatus of claim 7, wherein said manipulated variables adjustment unit temporarily corrects and uses the data in said database or corrects and updates the data in said database to obtain said new manipulated variables once again when said new manipulated variables are out of the manipulation available range of the apparatus.

11. The image forming apparatus of claim 10, wherein the apparatus determines whether the data in said database is temporarily corrected and used or updated based on said environmental state.

12. The image forming apparatus of claim 7, wherein said manipulated variables adjustment unit corrects the data in said database by linearly transforming the data in said database based on the relationship between said variables in said environmental state at the time.

13. An output image control method for controlling, with an image output apparatus being capable of image output and having a function to manipulate characteristics regarding qualities including an optical density of an image outputted by the apparatus, the qualities for a specific value in relation to environmental states including an environment in which said apparatus is placed and changes over time in performance characteristics, the method comprising the steps of:
storing representative data indicating a relationship between manipulated variables and controlled variables for predetermined representative manipulated variables in a specific environmental state, said manipulated variables being variables used for manipulating characteristics regarding said qualities, said controlled variables being indices of said qualities in a reference pattern that is an image used as a reference for obtaining the indices; and
obtaining new manipulated variables adjusted for controlling said qualities for a specific level by comparing the data indicating the relationship between said variables for said manipulated variables determined or calculated at the time in said environmental state at the time with representative data stored in said database in the course of controlling said qualities for a specific level,
and wherein the step of obtaining said new manipulated variables is a step of obtaining said new manipulated variables after the data in said database is corrected based on the data indicating the relationship between said variables in said environmental state at the time when necessary.

14. A machine readable medium bearing an output image control program for causing the apparatus to execute the steps of the method according to claim 13.
